(19) United States
(12) Patent Application Publication
(10) Pub. No.: US 2005/0078681 A1
(43) Pub. Date: Apr. 14, 2005

(54) Identifier assignment system, method, and program

(75) Inventors: Yoshifumi Sanuki, Kawasaki (JP); Junichi Kubota, Kawasaki-shi (JP); Shushi Takiyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/804,172

(22) Filed: Mar. 19, 2004

(30) Foreign Application Priority Data
Aug. 21, 2003 (JP) 2003-208295

(51) Int. Cl. H04L 12/28

(52) U.S. Cl. 370/395.5; 370/395.54; 709/245

(57) ABSTRACT

An IP address distribution system for distributing an IP address to a client device connected to an IP network based on distribution request information received from the client device, comprises: a lease condition storage unit that stores lease conditions corresponding to the client device indicating conditions relating to approval/prohibition of IP address distribution; an initial control unit that, when the distribution request information is received from the client device, approves the IP address distribution to the client device and stores initial lease conditions corresponding to the client device into lease condition storage unit, if the lease conditions corresponding to the client device are not stored in the lease condition storage unit; a condition modification unit that modifies the lease conditions corresponding to the client device stored in the lease condition storage unit; and an IP address distribution approval/prohibition control unit that controls approval/prohibition of IP address distribution to the client device as a transmission source of the distribution request information, based on the lease conditions corresponding to the client device stored in the lease condition storage unit.

### BACKGROUND OF THE INVENTION

The present invention relates to an identifier distribution system and method, and more particularly to an identifier distribution system and method such as a DHCP server for distributing an identifier to a PC (Personal Computer) or other such terminal (hereinafter, referred to as “PC terminal”) connected to an IP network.

In a network environment where a unique network identifier is used for communication, such as a network environment in which communication takes place according to a TCP/IP protocol, an IP address is generally distributed by a DHCP (Dynamic Host Configuration Protocol) server, to a PC terminal connected to the network. This IP address enables the PC terminal to be recognized within the IP network. Up until now, various proposals have been made, with particular consideration for security, for systems for distributing the IP address to the PC terminal connected to the IP network.

For example, according to one system (see Patent document 1), an authentication server is provided within the IP network, and the authentication server compares a user ID and a password sent from the PC terminal connected to the network against a pre-registered user ID and password of a legitimate user, to confirm that the user is the legitimate user. After this confirmation, the IP address is distributed to the PC terminal, which was the transmission source of the user ID and the password. In this kind of system, the IP address is distributed only to the PC terminal used by the legitimate user, whereby the security of the IP network environment-can be guaranteed.

According to another system (see Patent document 2), a combination of an ID (MTID) for specifying a device connectable to a network (home network) and an ID of a router (HGWID) provided on a communication path from the network to an ISP (Internet Service Provider) is pre-registered in a database. This database is provided to the ISP. Then, when the network device is connected (or when its power source is turned on) and the MTID is routed from the device, the router sends its HGWID along with the MTID to the ISP. If the combination of those matches the combination registered in the database, then the IP address is distributed to the device from the ISP. In this type of system, the IP address is distributed to the device only when it is confirmed that the device with the pre-registered ID has connected to the right network (which is identified by the router ID). Thus, the security of the network is guaranteed.

According to yet another system (see Patent document 3), a host name for a client which is to be managed by the system is pre-registered in the DHCP server. When an IP address setting request is received, if the host name of the client that was the source of the IP address setting request matches with the pre-registered host name, the IP address is distributed to the client from the DHCP server. In this type of system, if plural DHCP servers are present within the network, each DHCP server only needs to respond to requests from the client(s) that it manages. This enables reduction of network traffic. In addition, since the IP address will only be distributed to the client with the pre-registered name, the security within the network can be guaranteed.

A proposal has been made for a security system (e.g., see Patent document 4) in which forms of communication that are to be prohibited in the network are registered in advance, and a determination is made as to whether access being performed among terminals connected to the network matches the prohibited form of communication. Illegitimate access among the terminals is detected based on the results of this determination. This type of security system can be used to detect illegitimate access to another terminal even by a terminal that has already received the IP address distribution and connected to the network. Thus, security within the network can be improved.

[Patent Document 1]
JP 2003-30138 A

[Patent Document 2]
JP 2002-281061 A

[Patent Document 3]
JP 2000-59387 A

[Patent Document 4]
JP 7-264178 A

In the conventional systems for distributing an IP address to a communication device that uses an IP address or other identifier for communication on a network, the distribution of the identifier cannot be approved unless information about the device or user is fixedly pre-registered. Therefore, the conventional systems is not convenient for use in an intra-company network for a company where people come and go frequently, such as a network where people from outside the organization (e.g., someone visiting from another business entity or branch office etc.) frequently connect and use the PC terminal on a temporary basis.

Furthermore, cost and operational aspects are not advantageous when the type of security system is provided as an addition to the systems for distributing the identifiers.

### SUMMARY OF THE INVENTION

The present invention has been made to solve the problems in the conventional techniques, and provides an identifier assignment system, method, and program that enables a legitimate user to temporarily connect a communication device (PC terminal) to a network easily, and substantially eliminates illegitimate connections with the communication device.

An identifier assignment system (apparatus) for assigning an identifier to a communication device that uses a unique identifier to perform communication in accordance with the present invention, is characterized by comprising: managing unit that manages a communication device; and control unit that receives a request from the communication device, and assigns an identifier to the communication device in response to the request from the communication device if the request is within a predetermined duration of time from the assignment of the identifier to the communication device.

Preferably, the control unit always assigns the identifier in response to requests from an approved communication device.

Furthermore, the IP address (identifier) distribution system according to the present invention is an IP address distribution system for distributing an IP address to a client device (communication device) connected to the IP network based on distribution request information received from the client device, and may include: lease condition storage unit that stores lease conditions corresponding to the client device indicating conditions relating to approval/prohibition of IP address distribution; initial control unit that, when the distribution request information is received from the client device, approves the IP address distribution to the client device and stores initial lease conditions corresponding to the client device into lease condition storage unit, if the lease conditions corresponding to the client device are not stored in the lease condition storage unit; condition modification unit that modifies the lease conditions corresponding to the client device stored in the lease condition storage unit; and IP address distribution approval/prohibition control unit that controls approval/prohibition of IP address distribution to the client device as a transmission source of the distribution request information, based on the lease conditions corresponding to the client device stored in the lease condition storage unit.

In accordance with the construction, the IP address distribution is approved for the client device that is connected to the IP network for the first time, and the initial-lease conditions are set for the client device. Then, the lease conditions for the client device can be modified, and approval/prohibition of distribution of the IP address to the client device that sent the distribution request information is controlled based on those lease conditions. Therefore, the lease conditions for the client device can be managed dynamically, and by setting the initial lease conditions appropriately, the client device can connect temporarily to the IP network while preventing frequent illegitimate connections to the IP network by the client device.

Furthermore, according to the IP address distribution system of the present invention, the initial lease conditions include a term condition during which the IP address can be distributed, and the condition modification may include: unit that determines whether or not the term condition in the initial lease conditions stored in the lease condition storage unit corresponding to the client device is satisfied when the distribution request information is received from the client device; and lease prohibition setting unit that modifies the initial lease conditions to lease conditions for prohibiting the IP address distribution when it is determined that the term condition is not satisfied.

In accordance with the construction, the IP address is no longer distributed to the client device for which the term condition enabling distribution of the IP address in the initial lease conditions is no longer satisfied. Therefore, the illegitimate connection to the IP network can be prevented.

The term condition may be stipulated based on a unit time, and may also be stipulated based on the number of times that the distribution request information is received.

Furthermore, according to the IP address distribution system of the present invention, the condition modification unit may include unit that modifies the initial lease conditions corresponding to the client device to a set of normal lease conditions that are determined in advance based on information relating to execution of specific processing from the client device.

In accordance with the construction, the client device which was incapable of receiving the IP address distribution except under the initial lease conditions can be modified to become capable of receiving the IP address distribution under the normal conditions based on the specific processing performed for the client device.

In a system to which the IP address distribution system is applied, the normal lease conditions can be determined freely, such as always enabling the IP address distribution, etc.

Note that, in the case where the lease conditions include the term condition during which the IP address can be distributed, the condition modification unit may also include unit that extends for a predetermined duration of time the term condition stored in the lease condition storage unit corresponding to the client device when the distribution request information is received from the client device. In this case, as long as the client devices are continuously connected to the IP network, the term condition in the lease conditions corresponding to the client device is not expired, and thus the IP address distribution approval/prohibition control can be continued.

Further, in the case where the lease conditions include the term condition during which the IP address can be distributed, the condition modification unit may also include: unit that determines whether or not the term condition in the lease conditions stored in the lease condition storage unit is satisfied; and unit that deletes from the lease condition storage unit those lease conditions for which it is determined that the term condition is not satisfied.

In this case, it is not necessary to continuously manage the client device for which the term condition is no longer satisfied.

The condition modification unit may also include unit that modifies the lease conditions corresponding to the client device stored in the lease condition storage unit based on the information relating to the execution of the specific processing from the management device connected to the IP network. In this case, the lease conditions for the client device can be modified from the management device.

In accordance with the present invention, an identifier assignment method in which a computer or other device, machine or the like assigns an identifier to a communication device which uses a unique identifier to perform communication, includes: managing the communication device; receiving a request from the communication device; and assigning the identifier to the communication device in response to the request if the request is received within a predetermined duration of time from the assignment of the identifier to the communication device.

The present invention may also be configured as a program for causing a computer that assigns the identifier to the communication device that performs communication using the unique identifier to function as: managing unit that manages the communication device; and control unit that receives the request from the communication device, and assigns the identifier to the communication device in response to the request if the request is received within the predetermined time duration from the assignment of the identifier to the communication device. Furthermore, the present invention may also store such a program into a storage medium that can be read by the computer or other device, machine or the like.

### DESCRIPTION OF THE DRAWINGS

FIG. 1 is a diagram showing a system to which an IP address distribution system in accordance with an embodiment of the present invention is applied.

FIG. 2 is a diagram showing functional relationships among a DHCP server, a manager PC device, and a client PC device of the system shown in FIG. 1.

FIG. 3 is a flowchart showing a flow of processing executed when the DHCP server receives a lease request.

FIG. 4 is a flowchart showing a flow of registration procedure processing on the DHCP server.

FIG. 5 is a flowchart showing a flow of processing for organizing a lease status table, which is executed at predetermined intervals on the DHCP server.

FIG. 6 is a flowchart showing a flow of processing for changing the content of the lease status table on the DHCP server.

### DETAILED DESCRIPTION OF THE INVENTION

Hereinafter, explanation is made of an embodiment of the present invention, with reference to the drawings.

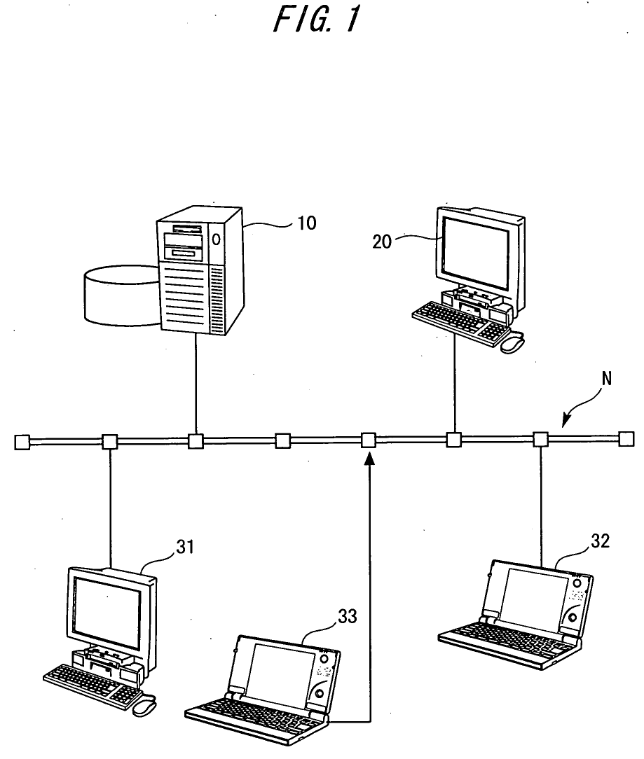

A system applying an IP address distribution system (DHCP server) according to the present invention is constructed as shown in FIG. 1, for example. This example shows an intra-company network system.

In FIG. 1, a DHCP server 10 (IP address distribution system) and a network manager PC 20 are connected to a predetermined IP network N (intra-company network). Further, client PC's 31, 32, 33 for performing processing within the IP network N are connected to the IP network N.

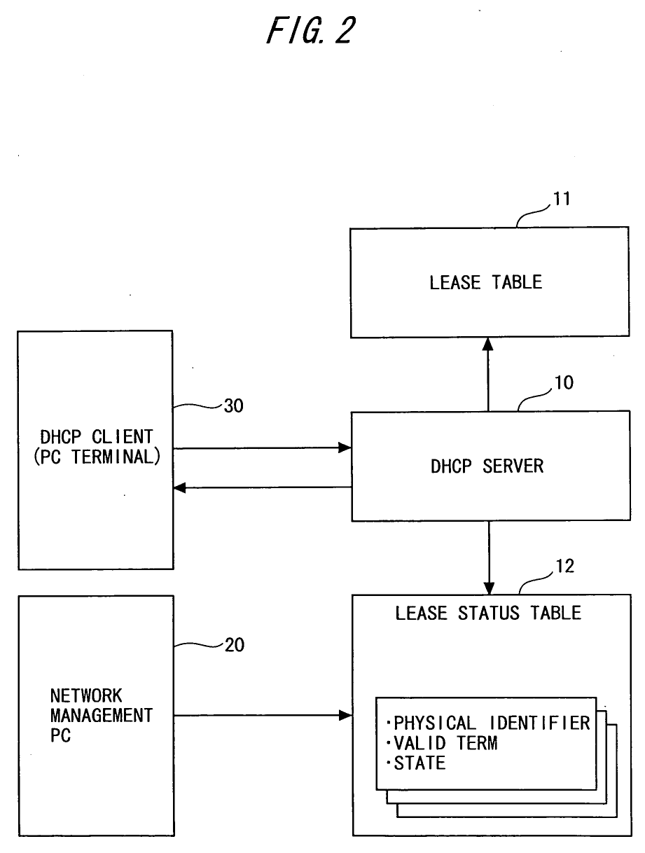

In such a system, functional relationships among the DHCP server 10, the network manager PC 20 and the client PC 30 (reference number 30 refers to the client PC's 31, 32, 33 shown in FIG. 1 as a group), are as shown in FIG. 2.

In FIG. 2, the DHCP server 10 sends and receives information to and from client PC 30 connected to the network N. The DHCP server 10 has a database, and in this database are stored: a lease table 11 stating IP addresses distributed to each client PC (MAC address), and the lease term; and a lease status table 12 stating lease conditions indicating conditions determining whether or not the IP address can be distributed to each client PC. The lease status table 12 has entries for a “physical identifier” (MAC address) specifying the client PC, and lease conditions (“valid term” and “state”). The “state” is set with “initial” indicating a lease start condition, “lease OK” indicating IP address distribution is approved, or “lease NO” indicating IP address distribution is prohibited.

When the client PC 30 is connected to the IP network (or when the power source is turned on while the client PC 30 is connected to the IP network N), the client PC 30 sends to the DHCP server 10 information (hereinafter, referred to as a “lease request”) for requesting distribution of an IP address. When the DHCP server 10 has received the lease request, the DHCP server 10 performs control to permit/prohibit distribution of the IP address based on the lease conditions described in the lease status table corresponding to the client PC that was the transmission source of the lease request. Further, when the DHCP server 10 has received the lease request, if there is no lease status table 12 for the client PC that was the transmission source of the lease request, then the DHCP server 10 creates a lease status table corresponding to the client PC (physical identifier) in which the lease condition is “state”=initial.

The network manager PC 20 can update the content of the lease status table 12 on a predetermined WEB screen provided on the DHCP server 10. Further, on the WEB screen for this registration provided on the DHCP server 10, the client PC 30 can update the setting of “state”=start to “state”=lease OK, in the lease status table 12.

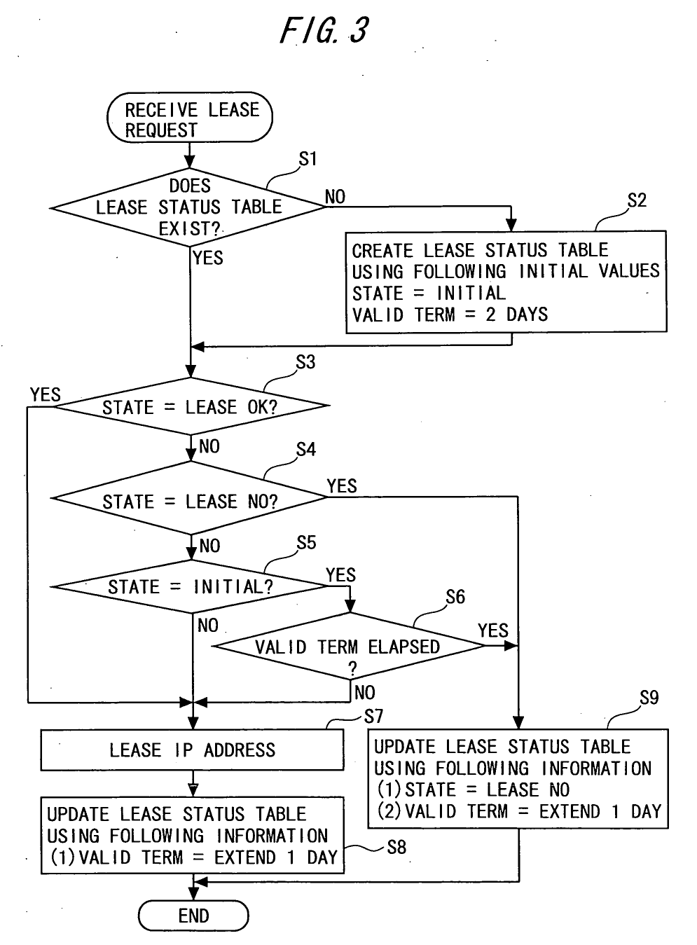

The DHCP server 10 executes the processing according to the procedure shown in FIG. 3, each time the lease request is received from the client PC 30. This processing is performed according to a program installed in the DHCP server 10. Note that, this program may be provided to the DHCP server 10 by unit of a CD-ROM or other storage medium, or may be provided to the DHCP server 10 via a network (including the IP network N), or may be stored in advance on a ROM, etc. of the DHCP server 10.

According to FIG. 3, when the DHCP server 10 receives the lease request from the client PC 30, the DHCP server 10 determines whether or not there exists the lease status table 12 corresponding to the client PC 30 that was the transmission source (S1). For example, the first time the client PC 30 is connected to the IP network N and it is determined that the lease status table 12 does not exist, the DHCP server 10 creates the lease status table 12 corresponding to the client PC 30 received with the lease request (S2). This lease status table 12 may be set with the following initial lease conditions, for example:
“state”=initial;
“valid term”=2 days.

Thereafter, the “state” in the lease status table 12 is confirmed (S3, S4, S5), and when it is confirmed that “state”=initial (NO at S3, NO at S4, YES at S5), the DHCP server 10 then determines whether or not the value set for the “valid term” has already elapsed (S6). When it is determined that the value (initial value=2 days) set for the “valid term” has not elapsed (NO at S6), the DHCP server 10 distributes (sends) an IP address selected from pre-pooled, unused IP addresses to the client PC 30 that was the transmission source of the lease request (S7). Then, the DHCP server 10 updates the “valid term” to a value extended by 1 day in the lease status table 12 corresponding to the client PC 30 to which the IP address was distributed (S8).

The client PC 30, which received the IP address distributed from the DHCP server 30 as described above, stores the IP address internally, thereby becoming capable of sending and receiving information on the IP network. Therefore, even if a temporary visitor to the company connects (for the first time) his own PC to the IP network (the intra-company network), he can use his PC on the IP network without any problems.

The client PC 30 can perform an official registration processing. The official registration processing is performed as follows.

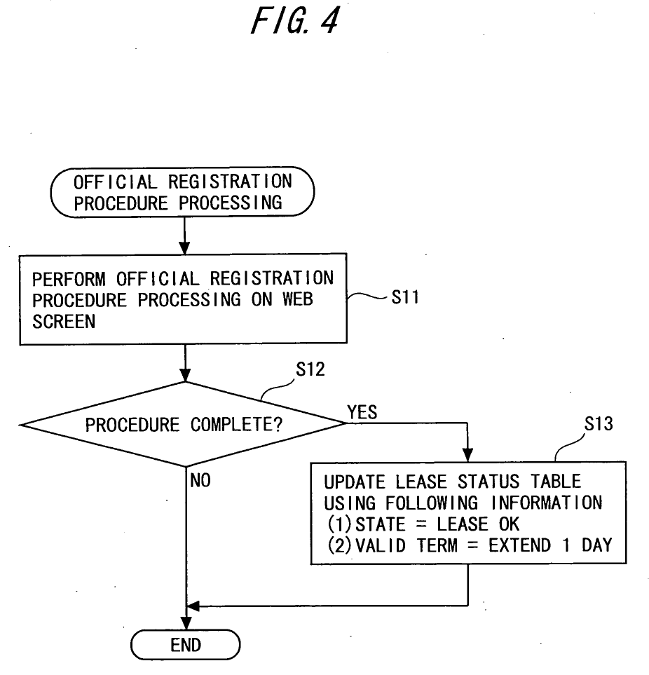

The client PC 30 uses a general-use browser function to execute the official registration procedure processing. Namely, the client PC 30 reads out the WEB screen for the official registration processing provided by the DHCP server 10, and sets the information according to setting procedures predetermined by the user. Then, the processing is performed according to the sequence shown in FIG. 4, at the DHCP server 10 that provides the WEB screen for the official registration processing. This processing is also performed according to a program provided to the DHCP server 10, similarly to the program for the processing shown in FIG. 3.

In FIG. 4, the predetermined official registration processing is performed based on the information set on the WEB screen using the client PC 30 (S11), and when it is determined that the processing is complete (YES at S12), the DHCP server 10 sets the lease conditions in the lease table 12 corresponding to the client PC 30, such that
“state”=lease OK; and
“valid term”=extend 1 day.
   In other words, “state”=initial is updated to “state”=lease OK, and the “valid term” setting value is updated to the value extended by one day.

Note that, in the course of the processing shown in FIG. 4, if the completion of the processing is not confirmed (NO at S12), then the official procedure processing is considered incomplete and the processing ends without updating the lease status table 12.

When the power source is turned on, etc. for the client PC 30 that has completed the official registration processing as described above and the DHCP server 10 receives the lease request from it, the following processing is then performed.

In FIG. 3, when the DHCP server 10 confirms the existence of the lease status table 12 corresponding to the client PC 30 that was the transmission source of the lease request (YES at S1), it then confirms the value set in the “state” in the respective lease status table 12. Then, when “state”=lease OK, which was set by the official registration processing as described above, is confirmed (YES at S3), the DHCP server 10 distributes the IP selected from the pre-pooled, unused IP addresses to the client PC 30 that was the transmission source of the lease request (S7), and updates the “valid term” to the value extended by 1 day, in the lease status table 12 corresponding to that client PC 30 (S8).

Accordingly, every time the DHCP server 10 receives the release request that is sent when the power source is supplied to the client PC 30 which completed the official registration processing, the DHCP server 10 distributes the IP address according to the processing (S1, S3, S7, S8). Therefore, the client PC 30 can send and receive information on the IP network N. Also, the “valid term” is extended by 1 day every time the lease request is outputted. Therefore, the client PC 30 can send and receive information on the IP network repeatedly without performing a special procedure.

For example, in the case where an illegitimate user who knows nothing about the official registration processing connects his own PC to the IP network, the DHCP server 10 performs the processing (S1-S9) to create the lease status table 12 for the PC with the settings for the initial lease conditions, and executes the distribution of the IP address. In other words, the illegitimate user's PC (hereinafter, referred to as the “illegitimate PC”) can also send and receive information on the IP network N. However, after that, when the value set as the “valid term” in the initial lease conditions elapses and no longer satisfies the initial lease conditions, the following processing prevents the illegitimate PC from being used on the IP network N when the illegitimate PC is connected to the IP network N again.

In FIG. 3, when the DHCP server 10 confirms the existence of the lease status table 12 corresponding to the illegitimate PC that was the transmission source of the lease request (YES at S1), the DHCP server 10 then confirms the value set as the “state” in the respective lease status table 12. Then, when the initial lease condition “state”=initial is confirmed (NO at S3, NO at S4, YES at S5), the DHCP server 10 determines whether or not the value of the “valid term” set in the lease status table 12 has elapsed (S6). In this case, the DHCP server 10 determines that the value set as the “valid term” has elapsed (YES at S6). Then, the DHCP server 10 updates the conditions stated in the lease status table 12 for the illegitimate PC to:
“state”=lease NO;
“valid term”=extend 1 day (S9).
   After that, the DHCP server 10 ends the processing without particularly distributing the IP address.

Thereafter, when the lease request from the illegitimate PC is received, the DHCP server 10 confirms that the lease condition set as described above in the lease status table 12 for the illegitimate PC is “state”=lease NO (YES at S1, NO at S3, YES at S4), and then extends by 1 day the value set for the “valid term” in the lease status table 12 (S9) and ends the processing without performing the distribution of the IP address.

In this way, the IP address is distributed to the illegitimate PC when it makes its first connection, but after the value set in the “valid term” elapses any connection to the IP network N is prohibited.

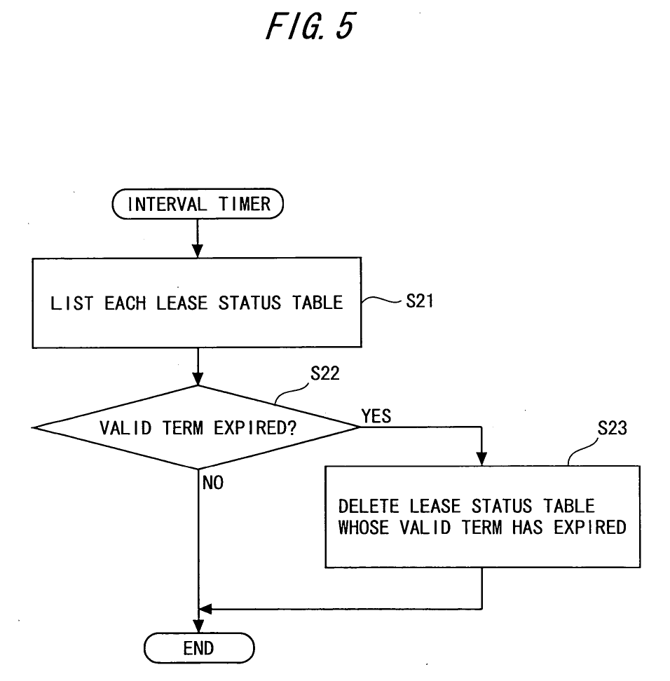

The DHCP server 10 executes organization of the lease status table 12 according to procedures shown in FIG. 5, independently of the processings (refer to FIGS. 3 and 4) at determined cycles (set as interval time). This processing is also executed according to a program provided to the DHCP server 10, similarly to the program for the processing in FIG. 3.

In FIG. 5, the DHCP server 10 sequentially reads out the lease tables 12 stored in the database (S21). Then, the DHCP server 10 confirms the “valid term” in each lease status table 12 (S12), and deletes the lease tables 12 where the “valid term” setting values have elapsed.

This eliminates subsequent unplanned processing (confirmation processing at S1 in FIG. 3) and managing by the DHCP server 10. Furthermore, as described above, the lease status table 12 that was created when the temporary visitor to the company connected (for the first time) his own PC to the IP network N (intra-company network) is also deleted when the value set as the “valid term” elapses. Therefore, in the case where he visits the company again after the valid term has elapsed and connects his own PC to the IP network N, a new lease status table 12 set with the initial lease conditions (“state”=initial, “valid term”=2 days) is created. Therefore, this person can use his PC on the IP network as described above without any problem.

Note that, the DHCP server 10 manages the relationship between the IP address distributed as described above and the client PC that the IP address was distributed to by recording the relationship into a lease table 11. The DHCP server 10 can collect the IP addresses saved to each client PC connected to the IP network N by following a broadcast or multicast communications method. Then, the collected results and the relationships between the client PC's and the IP addresses recorded in the lease table 11 are compared to determine whether or not there exists on the IP network a PC that has saved an illegitimate IP address. Then, the DHCP server 10 can inform the result of this determination to the network manager PC 20.

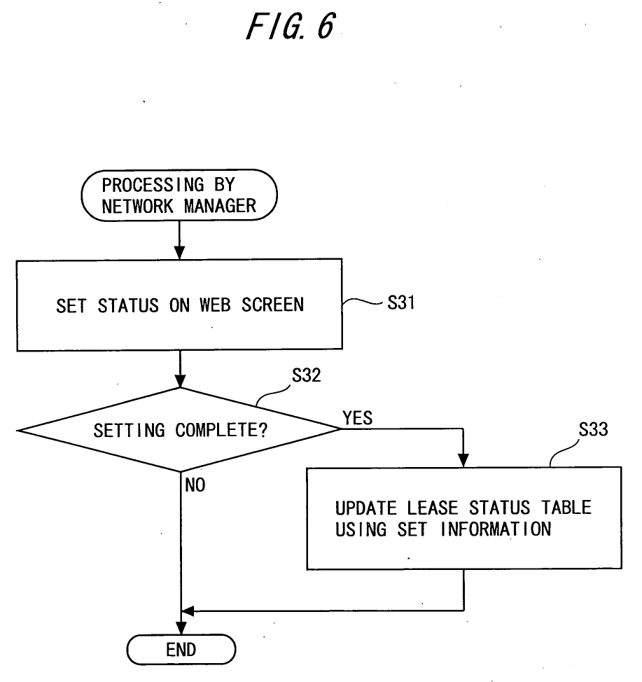

Further, in the system, the network manager PC 20 uses the general-purpose browser function to modify the content of the lease status table 12 corresponding to each client PC stored in the database of the DHCP server 10. More specifically, the network manager PC 20 reads out the management WEB screen provided by the DHCP server 10, and sets the information according to the predetermined setting operations by a manager. Then, at the DHCP server 10 providing the management WEB screen, the processing is executed according to the sequence shown in FIG. 6. This processing is also executed according to the program provided to the DHCP server 10, similarly to the program for the processing shown in FIG. 3.

In FIG. 6, the information (the respective client PC, the lease conditions, etc.) set on the WEB screen using the network PC 20 is obtained (S31), and when it is determined that the setting is complete (YES at S32), the DHCP server 10 updates the lease conditions to the lease conditions set for that client PC (S33), in the lease table 12 corresponding to the set client PC 30.

Note that, in the course of the processing shown in FIG. 6, if it is not confirmed that the setting is complete (NO at S32), then the setting processing is assumed to be incomplete and the processing ends without updating the lease status table 12.

In this way, the network manager PC 20 can be used to change the content of the lease status table 12 stored in the database of the DHCP server 10. Therefore, for example, in a case where an illegitimate PC connected to the IP network N is detected, the network manager PC 20 can be used to update the lease status table 12 corresponding to the illegitimate PC to:
“state”=lease NO;
“valid term”=extend 1 day.
   By doing this, subsequent connections to the IP network N by the illegitimate PC can be prohibited.

In accordance with a DHCP server 10 (IP address distribution system) according to the embodiment, the control of whether or not to distribute the IP addresses to each client PC connected to the IP network N can be performed dynamically based on the lease status table 12 that is created and whose content (lease conditions) are updated for each client PC 30. Then, the IP address is distributed unconditionally and a lease conditions management table set with the initial lease conditions is prepared for the client PC that is connected to the IP network for the first time. Therefore, even if the temporary visitor to the company connects (for the first time) his own PC to the IP network N (intra-company network, he can use his PC on the network without any problem.

Further, after the value set in the “valid term” in the initial lease conditions has elapsed, “state”=initial is updated to “state”=lease NO, in the lease status table 12. Therefore, the connection of the illegitimate PC to the IP network N after the elapse of the value set in the “valid term” can be prevented without using an authentication server or other resources.

Furthermore, in the system, each client PC 30 can perform the official registration procedure processing on the WEB screen provided by the DHCP server 10, and the network manager PC 20 can also perform the processing to change the content of the lease status table 12 on the WEB screen provided by the DHCP server 10. Therefore, each client PC 30 and the network manager PC 20 can perform their processing just by providing the general-purpose browser function without providing a special function (application).

Note that, the system was envisioned in an intra-company network. However, networks for building this system are not limited to this example, and the network may be selected freely. For example, the system can be applied in a network connection environment (Hotspot (trademark)) configured at a place where unspecified people congregate (a restaurant or public facility). This type of system is operated by permitting use of the Hotspot (trademark) as compensation for the user. The system can be utilized effectively for the purpose of excluding illegitimate usage or allowing usage for a given period of time.

The IP network may be a wire network or a wireless network (e.g., wireless LAN).

A program for making a computer or other device or a machine which realizes any of the functions on can be recorded onto a storage medium readable by a computer or other unit. Then, the computer or the like can read and execute the program on the storage medium, and provide the functions.

Here, the storage medium that is readable by the computer, etc. refers to a storage medium in which data or a program, etc. can be accumulated by electric, electro-magnetic, optical, mechanical or chemical processes, and can be read from the computer. Examples of such storage media which can be removed from the computer include a flexible disk, an optical magnetic disk, a CD-ROM, a CD-R/W, a DVD, a DAT, 8-mm tape, a memory card, etc.

Storage media that are fixed to the computer or the like include a hard disk, a ROM (Read Only Memory), etc.

As explained above, in accordance with the present invention, a legitimate user can temporarily connect a communication device (PC terminal) to a network easily, and illegitimate connection of the communication device can be substantially eliminated. For example, assignment of an IP address or other identifier to each communication device on the network can be controlled dynamically. Furthermore, by appropriately setting initial conditions for the assignment, temporary access by the communication device to the network can be enabled while preventing frequent illegitimate connection to the network by the communication device.

1. An identifier assignment apparatus for assigning an identifier to a communication device which uses a unique identifier to perform communication, comprising:
a managing unit that manages the communication device; and
a control unit that receives a request from the communication device, and assigns an identifier to the communication device in response to the request if the request is within a predetermined duration of time from the assignment of the identifier to the communication device.

2. An identifier assignment apparatus according to claim 1, wherein the control unit always assigns the identifier in response to requests from an approved communication device.

3. An identifier assignment apparatus for assigning an identifier to a communication device which uses a unique identifier to perform communication, comprising:
a lease condition storage unit that stores lease conditions corresponding to the communication device indicating conditions relating to approval/prohibition of identifier distribution;
an initial control unit that, when the distribution request information is received from the communication device, approves the identifier distribution to the communication device and stores initial lease conditions corresponding to the communication device into lease condition storage unit, if the lease conditions corresponding to the communication device are not stored in the lease condition storage unit;
a condition modification unit that modifies the lease conditions corresponding to communication device stored in the lease condition storage unit; and
an identifier distribution approval/prohibition control unit that controls approval/prohibition of identifier distribution to the communication device as a transmission source of the distribution request information, based on the lease conditions corresponding to the communication device stored in the lease condition storage unit.

4. An identifier assignment apparatus according to claim 3, in which
the initial lease conditions include a term condition during which the identifier can be distributed, and
the condition modification unit includes:
a unit that determines whether or not the term condition in the initial lease conditions stored in the lease condition storage unit corresponding to the communication device is satisfied when the distribution request information is received from the communication device; and
a lease prohibition setting unit that modifies the initial lease conditions to lease conditions for prohibiting the identifier distribution when it is determined that the term condition is not satisfied.

5. An identifier assignment apparatus according to claim 3, in which the condition modification unit includes unit that modifies the initial lease conditions corresponding to the communication device to a set of normal lease conditions in which identifier distribution is determined in advance based on information relating to execution of specific processing from the communication device.

6. An identifier assignment apparatus according to claim 3, in which
the lease conditions include the term condition during which the identifier can be distributed, and
the condition modification unit includes a unit that extends for a predetermined duration of time the term condition stored in the lease condition storage unit corresponding to the communication device when the distribution request information is received from the communication device.

7. An identifier assignment apparatus according to claim 3, in which
the lease conditions include the term condition during which the identifier can be distributed, and
the condition modification unit includes:
a unit that determines whether or not the term condition in the lease conditions stored in the lease condition storage unit is satisfied; and
a unit that deletes from the lease condition storage unit those lease conditions for which it is determined that the term condition is not satisfied.

8. An identifier assignment apparatus according to claim 3, in which the condition modification unit includes unit that modifies the lease conditions corresponding to the communication device stored in the lease condition storage unit based on the information relating to the execution of the specific processing from a management device.

9. An identifier assignment apparatus according to claim 1, wherein
the identifier is IP address.

10. An identifier assignment method for assigning an identifier to a communication device which uses a unique identifier to perform communication, comprising:
a managing step of managing the communication device; and
a control step of receiving a request from the communication device, and assigning an identifier to the communication device in response to the request if the request is within a predetermined duration of time from the assignment of the identifier to the communication device.

11. An identifier assignment method according to claim 10, wherein the control step always assigns the identifier in response to requests from an approved communication device.

12. An identifier assignment method for assigning an identifier to a communication device which uses a unique identifier to perform communication, comprising:
a lease condition storage step of storing lease conditions corresponding to the communication device indicating conditions relating to approval/prohibition of identifier distribution;
an initial control step of, when the distribution request information is received from the communication device, approving the identifier distribution to the communication device and storing initial lease conditions corresponding to the communication device by lease condition storage step, if the lease conditions corresponding to the communication device are not stored by the lease condition storage step;
a condition modification step of modifying the lease conditions corresponding to communication device stored by the lease condition storage step; and
an identifier distribution approval/prohibition control step of controlling approval/prohibition of identifier distribution to the communication device as a transmission source of the distribution request information, based on the lease conditions corresponding to the communication device stored by the lease condition storage step.

13. An identifier assignment method according to claim 12, in which
the initial lease conditions include a term condition during which the identifier can be distributed, and
the condition modification step includes:
a step of determining whether or not the term condition in the initial lease conditions stored by the lease condition storage step corresponding to the communication device is satisfied when the distribution request information is received from the communication device; and
a lease prohibition setting step of modifying the initial lease conditions to lease conditions for prohibiting the identifier distribution when it is determined that the term condition is not satisfied.

14. An identifier assignment method according to claim 12, in which the condition modification step includes a step of modifying the initial lease conditions corresponding to the communication device to a set of normal lease conditions in which identifier distribution is determined in advance based on information relating to execution of specific processing from the communication device.

15. An identifier assignment method according to claim 12, in which
the lease conditions include the term condition during which the identifier can be distributed, and
the condition modification step includes a step of extending for a predetermined duration of time the term condition stored by the lease condition storage step corresponding to the communication device when the distribution request information is received from the communication device.

16. A storage medium storing a program for assigning an identifier to a communication device which uses a unique identifier to perform communication, the program comprising:
a managing step of managing the communication device; and
a control step of receiving a request from the communication device, and assigning an identifier to the communication device in response to the request if the request is within a predetermined duration of time from the assignment of the identifier to the communication device.

17. A storage medium according to claim 16, wherein the control step always assigns the identifier in response to requests from an approved communication device.

18. A storage medium storing a program for assigning an identifier to a communication device which uses a unique identifier to perform communication, the program comprising:
a lease condition storage step of storing lease conditions corresponding to the communication device indicating conditions relating to approval/prohibition of identifier distribution;
an initial control step of, when the distribution request information is received from the communication device, approving the identifier distribution to the communication device and storing initial lease conditions corresponding to the communication device by lease condition storage step, if the lease conditions corresponding to the communication device are not stored by the lease condition storage step;
a condition modification step of modifying the lease conditions corresponding to communication device stored by the lease condition storage step; and
an identifier distribution approval/prohibition control step of controlling approval/prohibition of identifier distribution to the communication device as a transmission source of the distribution request information, based on the lease conditions corresponding to the communication device stored by the lease condition storage step.

19. A storage medium according to claim 18, in which
the initial lease conditions include a term condition during which the identifier can be distributed, and
the condition modification step includes:
a step of determining whether or not the term condition in the initial lease conditions stored by the lease condition storage step corresponding to the communication device is satisfied when the distribution request information is received from the communication device; and
a lease prohibition setting step of modifying the initial lease conditions to lease conditions for prohibiting the identifier distribution when it is determined that the term condition is not satisfied.

20. A storage medium according to claim 18, in which the condition modification step includes a step of modifying the initial lease conditions corresponding to the communication device to a set of normal lease conditions in which identifier distribution is determined in advance based on information relating to execution of specific processing from the communication device.

21. A storage medium according to claim 18, in which
the lease conditions include the term condition during which the identifier can be distributed, and
the condition modification step includes a step of extending for a predetermined duration of time the term condition stored by the lease condition storage step corresponding to the communication device when the distribution request information is received from the communication device.
